(19) United States
(12) Patent Application Publication
(10) Pub. No.: US 2013/0097095 A1
(43) Pub. Date: Apr. 18, 2013

(54) Mobile Transport Tendering

(71) Applicants: Jan Rumig, Malsch (DE); Sabine Hamlescher, Mannheim (DE); Michael Schweitzer, Leimen (DE)

(72) Inventors: Jan Rumig, Malsch (DE); Sabine Hamlescher, Mannheim (DE); Michael Schweitzer, Leimen (DE)

(73) Assignee: SAP AG, Walldorf (DE)

(21) Appl. No.: 13/328,928

(22) Filed: Dec. 16, 2011

Related U.S. Application Data
(60) Provisional application No. 61/547,618, filed on Oct. 14, 2011.

(51) Int. Cl. G06Q 50/28

(52) U.S. Cl. 705/334; 705/330

(57) ABSTRACT

The present disclosure involves systems, software, and computer implemented methods for mobile transport tendering. One process includes operations for identifying at least one transportation management server providing information on at least one shipping opportunity, each transportation management server associated with a shipper, identifying the at least one shipping opportunity associated with at least one of the identified transportation management servers at a mobile device, and presenting at least a subset of the at least one identified shipping opportunity at the mobile device. Identifying the at least one shipping opportunity associated with the at least one of the identified transportation management servers can include sending a request to each of the at least one identified transportation management servers for shipping opportunities associated with the shipper and receiving a set of shipping opportunities from at least one of the identified transportation management servers.

### CLAIM OF PRIORITY

This application claims priority under 35 U.S.C, §119 to U.S. Provisional Application No. 61/547,618, filed Oct. 14, 2011, the entire disclosure of which is incorporated herein by reference.

### TECHNICAL FIELD

The present disclosure relates to mobile systems and methods for transportation management.

### BACKGROUND

A transportation management (TM) system is a subset of supply chain management concerning transportation operations and may be part of or associated with an enterprise resource planning (ERP) system. A TM system sits between an ERP or legacy order processing and warehouse/distribution module or company. A typical scenario can include both inbound (procurement) and outbound (shipping) orders to be evaluated by the TM system, the TM system offering the user various suggested routing solutions. These solutions are evaluated by the user for reasonableness and are passed along to the transportation provider analysis module to select the best mode and least cost provider.

### SUMMARY

The present disclosure involves systems, software, and computer implemented methods for mobile transport tendering. One process includes operations for identifying at least one transportation management server providing information on at least one shipping opportunity, each transportation management server associated with a shipper, identifying the at least one shipping opportunity associated with at least one of the identified transportation management servers at a mobile device, and presenting at least a subset of the at least one identified shipping opportunity at the mobile device. Identifying the at least one shipping opportunity associated with the at least one of the identified transportation management servers can include sending a request to each of the at least one identified transportation management servers for shipping opportunities associated with the shipper and receiving a set of shipping opportunities from at least one of the identified transportation management servers.

While generally described as computer implemented software embodied on non-transitory media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 provides an example environment 100 for performing operations associated with mobile transport tendering.

FIG. 2 illustrates an example interaction between components in an example architecture associated with the mobile transport tendering.

FIG. 3 provides an example diagram of a carrier receiving various transport opportunities via a mobile device.

FIG. 4A is a flowchart of an example method 400 for identifying and interacting with at least one shipping opportunity at a mobile device.

FIG. 4B is a flowchart of an example method for analyzing and sorting a plurality of shipping opportunities at a mobile device.

FIGS. 5A-E provide example screenshots from an example mobile transport tendering application.

### DETAILED DESCRIPTION

As markets expand globally and supply chain velocity and complexity increases, entities desire to leverage and optimize their company's transportation management competitively. To do so, entities request sensing changes and appropriate real-time reactions to network events, while improving visibility and responsiveness. Current transportation management applications allow consolidation of orders and optimization of shipments across a company or entity to maximize return on transportation costs. Information can be shared and orders can be combined with carriers and forwarders, allowing the integration of business partners into a company's or entity's transportation processes. Transportation management planning capabilities can enable an entity to, for instance:
Optimize shipments, assign carriers to shipments, and tender shipments to assigned carriers;
Consolidate orders and optimize shipments from a centralized location or distributed business units;
Select carriers, calculate freight costs, settle shipment costs, and print documents; and
Use denied-party and embargo lists for international shipping, among others.

Transportation management applications can allow users and entities to calculate and settle freight costs based on actual shipments and current freight rates, and use this information to verify invoices sent from carriers or from self-billing transportation service providers.

More generally, transportation management (TM) can manage the transport of goods from one party to another. TM can also assist a shipper to find an external carrier in the case that it does not want to carry out the transport itself. In this so-called tendering process, transport opportunities (freight requests for quotation) are sent out to one or multiple carriers who can, in turn, submit offers back to the shipper. The offers are then evaluated by the TM system, and the carrier submitting the best offer will be awarded and will later carry out the transport. An effective tendering process requires short reaction times from the carriers. Therefore, it is important that the carriers have ad-hoc access to their opportunities wherever they are (at their office, en route, at the customer, etc.) in order to react as soon as possible.

A carrier can be in contact with multiple shippers, providing the carrier with an overview regarding a set of current opportunities and his own availability. With that knowledge, the carrier can efficiently plan and schedule their offers in order to identify geographical and time-wise synergies and to find the financially most attractive opportunities. As tendering is a time-critical and competitive process, real-time access to new opportunities is key so as to allow the carrier to react immediately at any place or time.

The present disclosure describes a mobile application in the area of tendering that can foster fast and efficient management of transport opportunities and communication between a carrier and its shippers. The mobile application can provide at least the following functionality:
Provide a view of opportunities of different shippers at a glance;
Provide an overview of new opportunities and ability to quickly create offers;
Provide an overview of already created offers;
Provide an overview of offers that have been awarded by the shipper;
Provide an overview of existing appointments from previous offers allowing identification of time conflicts;
Provide a geographical display of opportunities;
Provide the ability to easily contact communication partners, e.g. shipper or consignee, easily from within the application (via e-mail, phone, etc.); and
Provide tools for making delivery appointments.

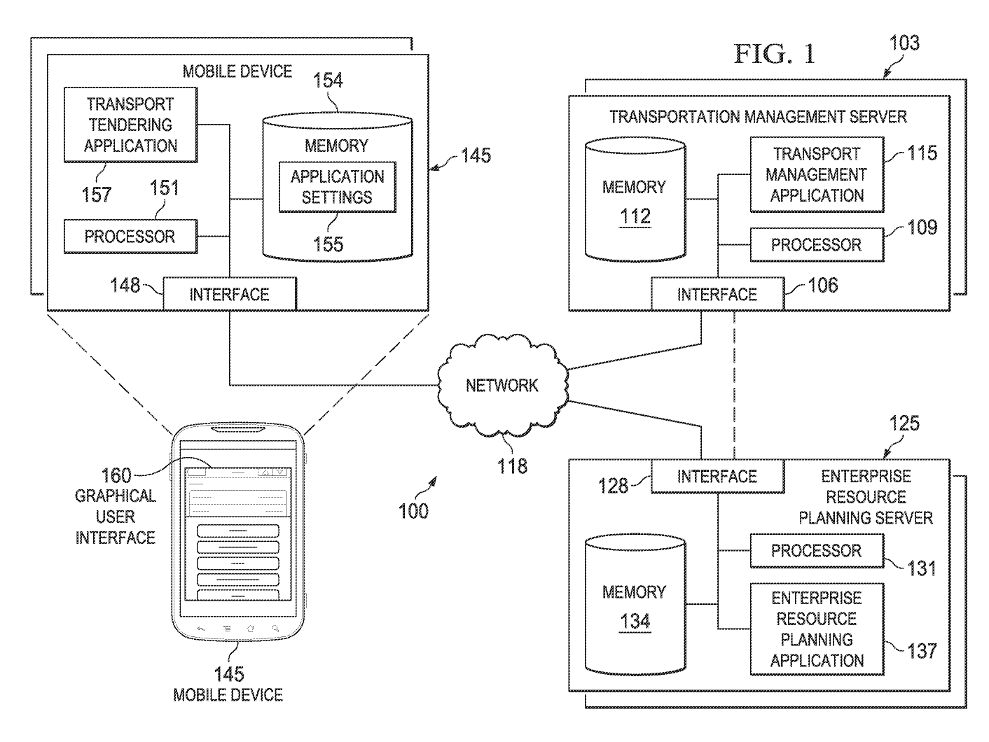

FIG. 1 provides an example environment 100 for performing operations associated with mobile transport tendering. As illustrated, the environment includes a plurality of mobile devices 145, a network 118, a transportation management (TM) server 103 (executing a TM application 115), and an enterprise resource planning (ERP) server 125 (executing an ERP application 137). Each mobile device 145, which can include mobile phones, smartphones, tablet computers, laptops, and other mobile computing systems, can each execute a transport tendering application 157. Using connections via a network 118, the mobile devices 145 and their transport tendering applications 157 can correspond and connect with one or more TM servers 103 executing different TM applications 115. The TM servers 103 (and corresponding TM applications 115) can correspond and communicate with at least one ERP server 125 and corresponding ERP applications 137. The ERP application 137 can provide additional enterprise functionality, and may work with the TM servers 103 and TM applications 115 to provide end-to-end services across an enterprise. In general, the TM applications 115 can manage operations associated with the transport of goods from one party to another. The TM application 115 can assist a shipper to locate an external carrier to carry out the shipment by receiving the parameters for a particular shipping job or operation and determining an appropriate carrier with whom to assign the shipment and delivery. The ERP server 125 is an optional component, and is not required to perform the tendering functions of the TM application 115.

During a tendering process, transport opportunities (e.g., freight requests for quotation) associated with a particular shipper's requirements can be sent out to multiple carriers, where the carriers receiving the opportunities can determine whether to submit a quotation for a particular job. The information included in the transport opportunity can include the parameters of a particular job or operation, including the job or operation's geographic location(s), time requirements, parties, financial considerations, closing bidding time, and/or other factors relevant to the carriers. In the illustrated environment of FIG. 1, at least one carrier is associated with at least one of the mobile devices 145, and can use the corresponding mobile device's transport tendering application to receive information associated with the one or more transport opportunities. Each receiving carrier (via one of the mobile devices 145) can analyze the opportunity to determine whether the particular job or operation is of interest or feasible to accept. The carriers can then choose to submit offers, or quotations, to the TM server 103 for consideration and analysis by an automated bidding/quotation system executed by the TM server 103 (or other suitable server or system) and/or manually by a representative of the shipper. The submitted offers are evaluated at the TM server 103, with the carrier that submitted the best offer as determined by the analysis being provided with the job. Because the carriers are provided the transport opportunities via the mobile transport tendering application 157, the carriers can immediately, or quickly after receipt, analyze and respond to particular transport opportunities with their bids. In some instances, notifications of available opportunities may be provided to the mobile devices 145 through alternative channels, including short message service (SMS) messages, social messaging messages or events (e.g., tweets), RSS feeds, or other suitable communication channels.

Carriers can also benefit through use of the TM application 115. For example, a carrier can be in contact with multiple shippers. In doing so, the carrier can be provided with an overview regarding all current opportunities and the carrier's own availability to determine whether various jobs can be accepted and/or bid upon. The mobile transport tendering application 157 can provide the carrier with relevant information associated with new and available opportunities and the carrier's current availability. With that information, the carrier can efficiently plan and schedule its bidding and current projects in order to identify geographical and time-based synergies. The carrier's real-time access via the mobile device 145 and the transport tendering application 157 provides carriers with an immediate tool for analyzing shipment opportunities. The present disclosure, for example, may be especially beneficial to self-employed truck drivers or other small carrier businesses, allowing them to manage their opportunities and schedules themselves while they are en-route without requiring access to a backend system to perform the scheduling.

In general, the TM server 103 is any server that stores and executes one or more TM applications 115. For example, the TM server 103 may be a Java™ 2 Platform, Enterprise Edition (J2EE)®-compliant application server that includes Java™ technologies such as Enterprise JavaBeans® (EJB), J2EE® Connector Architecture (JCA), Java™ Messaging Service (JMS), Java™ Naming and Directory Interface (JNDI), and Java™ Database Connectivity (JDBC). In some instances, the TM server 103 may store a plurality of various other applications, while in other instances, the TM server 103 may be a dedicated server meant to store and execute a particular TM application 115 and its related functionality. In some instances, the TM server 103 may comprise a web server or be communicably coupled with a web server, where one or more of the TM applications 115 associated with the TM server 103 represent web-based (or web-accessible) applications accessed and executed through requests and interactions received on the mobile device 145, executing the transport tendering application 157 (or other suitable application) operable to interact with the programmed tasks or operations of the corresponding TM application 115.

At a high level, the TM server 103 comprises an electronic computing device operable to receive, transmit, process, store, or manage data and information associated with the environment 100. The TM server 103 illustrated in FIG. 1 can be responsible for receiving application requests from one or more mobile devices 145 (as well as any other entity or system interacting with the TM server 103, including desktop or other, non-mobile systems), responding to the received requests by processing said requests in the associated TM applications 115, and sending the appropriate responses from the TM application 115 back to the requesting mobile device 145 or other requesting system. The TM application 115 can also process and respond to local requests from a user locally accessing the TM server 103. Accordingly, in addition to requests from the mobile devices 145 illustrated in FIG. 1, requests associated with a particular TM application 115 may also be sent from internal users, external or third-party customers, and other associated business applications or business processes, as well as any other appropriate entities, individuals, systems, or computers. The TM server 103 may be in communication with the ERP system 125 and/or one or more mobile devices 145, such that the particular implementations of the TM applications 115 can retrieve information relevant to particular transport jobs or shipments, and provide that information to the mobile devices 145 via the corresponding transport tendering application 157. In some instances, the TM application 115 may be a web-based application executing functionality associated with a networked or cloud-based process. Still further, the TM server 103 may respond to requests from mobile devices 145 or other entities, including those accessing the TM server 103 directly.

As used in the present disclosure, the term “computer” is intended to encompass any suitable processing device. For example, although FIG. 1 illustrates a single TM server 103, environment 100 can be implemented using any number of TM servers, as well as computers other than servers, including a server pool. Indeed, the TM server 103 may be any computer or processing device such as, for example, a blade server, general-purpose personal computer (PC), Macintosh®, workstation, UNIX-based workstation, or any other suitable device. In other words, the present disclosure contemplates computers other than general purpose computers, as well as computers without conventional operating systems. Further, the illustrated composite application server 103 may be adapted to execute any operating system, including Linux, UNIX, Windows, Mac OS®, or any other suitable operating system.

In the illustrated implementation of FIG. 1, the TM server 103 includes an interface 106, a processor 109, a memory 112, and a TM application 115. In some instances, the TM server 103 and its illustrated components may be separated into multiple components executing at different servers and/or systems. Thus, while illustrated as a single component in the example environment 100 of FIG. 1, alternative implementations may illustrate the TM server 103 as comprising multiple parts or portions accordingly.

FIG. 1 depicts a server-client environment, but could also represent a cloud-computing network based on particular deployment options. Various other implementations of the illustrated environment 100 can be provided to allow for increased flexibility in the underlying system, including multiple TM servers 103 performing or executing one or more additional or alternative instances of the TM applications 115 (for instance, for different shippers and/or carriers), as well as other applications associated with or related to the TM application 115. In those instances, the different TM servers 103 may communicate with each other via a cloud-based network or through the connections provided by network 118.

The interface 106 is used by the TM server 103 to communicate with other systems in a client-server or other distributed environment (including within environment 100) connected to the network 118 (e.g., one of the mobile devices 145, as well as other systems communicably coupled to the network 118). The interface 106 generally comprises logic encoded in software and/or hardware in a suitable combination and operable to communicate with the network 118. More specifically, the interface 106 may comprise software supporting one or more communication protocols associated with communications such that the network 118 or the interface's hardware is operable to communicate physical signals within and outside of the illustrated environment 100.

Generally, the TM server 103 may be communicably coupled with a network 118 that facilitates wireless or wireline communications between the components of the environment 100 (i.e., between the TM server 103, one or more mobile devices 145, and/or the ERP server 125), as well as with any other local or remote computer, such as additional clients, servers, or other devices communicably coupled to network 118, including those not illustrated in FIG. 1. In the illustrated environment, the network 118 is depicted as a single network, but may be comprised of more than one network without departing from the scope of this disclosure, so long as at least a portion of the network 118 may facilitate communications between senders and recipients. In some instances, one or more of the components associated with the TM server 103 may be included within the network 118 as one or more cloud-based services or operations.

The network 118 may be all or a portion of an enterprise or secured network, while in another instance, at least a portion of the network 118 may represent a connection to the Internet. In some instances, a portion of the network 118 may include a portion of a cellular or mobile data network or other network capable of relaying short message service (SMS) or multimedia messaging service (MMS) messages, as well as other suitable mobile data messaging. In some instances, a portion of the network 118 may be a virtual private network (VPN). Further, all or a portion of the network 118 can comprise either a wireline or wireless link. Example wireless links may include 802.11a/b/g/n, 802.20, WiMax, 3G, 4G (i.e., LTE), and/or any other appropriate wireless link. In other words, the network 118 encompasses any internal or external network, networks, sub-network, or combination thereof operable to facilitate communications between various computing components inside and outside the illustrated environment 100. The network 118 may communicate, for example, Internet Protocol (IP) packets, Frame Relay frames, Asynchronous Transfer Mode (ATM) cells, voice, video, data, and other suitable information between network addresses. The network 118 may also include one or more local area networks (LANs), radio access networks (RANs), metropolitan area networks (MANs), wide area networks (WANs), all or a portion of the Internet, and/or any other communication system or systems at one or more locations.

As illustrated in FIG. 1, the TM server 103 includes a processor 109. Although illustrated as a single processor 109 in the TM server 103, two or more processors may be used in the TM server 103 according to particular needs, desires, or particular embodiments of environment 100. The processor 109 may be a central processing unit (CPU), a blade, an application specific integrated circuit (ASIC), a field-programmable gate array (FPGA), or another suitable component. Generally, the processor 109 executes instructions and manipulates data to perform the operations of the TM server 103 and, specifically, the functionality associated with the corresponding TM application 115. In one implementation, the server's processor 109 executes the functionality required to receive and respond to requests and instructions from the mobile devices 145, among others.

Regardless of the particular implementation, “software” may include computer-readable instructions, firmware, wired or programmed hardware, or any combination thereof on a non-transitory medium operable when executed to perform at least the processes and operations described herein. Indeed, each software component may be fully or partially written or described in any appropriate computer language including C, C++, ObjectiveC, Java™, Visual Basic, ABAP, assembler, Perl®, any suitable version of 4GL, as well as others. It will be understood that while portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components, as appropriate. In the illustrated environment 100, each processor 109 executes the corresponding TM application 115 stored on the associated TM server 103. In some instances, a particular TM server 103 may be associated with the execution of two or more TM applications 115 (and other related components), as well as one or more distributed applications executing across two or more TM servers 103.

At a high level, the TM application 115 is any application, program, module, process, or other software that may execute, change, delete, generate, or otherwise manage information associated with a particular TM server 103, and in some cases, one or more business process processes performing and executing business process-related steps and events associated with transportation management. In general, the TM server 103 and the TM application 115 are the central components for planning transportation requirements and performing freight building and the scheduling of transports. Using the TM system 103 and TM application 115, a shipper can manage transportation of goods to a particular buyer, recipient, or customer.

The TM server 103, as illustrated, further includes memory 112 storing information associated with the TM server 103 and TM application 115. Memory 112 can store data and program instructions. Memory 112 may include any memory or database module and may take the form of volatile or non-volatile memory including, without limitation, magnetic media, optical media, random access memory (RAM), read-only memory (ROM), removable media, or any other suitable local or remote memory component. Memory 112 may store various objects or data, including classes, frameworks, applications, backup data, business objects, jobs, web pages, web page templates, database tables, processes, process contexts, repositories storing services local to the TM server 103, and any other appropriate information including any parameters, variables, algorithms, instructions, rules, constraints, or references thereto associated with the purposes of the TM server 103 and the TM application(s) 115. In some implementations, including a cloud-based system, some or all of memory 112 may be stored remotely from the TM server 103, and communicably coupled to the TM server 103 (i.e., via network 118).

In the illustrated example, the TM system 103 and the TM application 115 can access at least a portion of the ERP server 125 and ERP application 137, where additional information associated with sales orders that form the basis of one or more shipments, transports, or other deliveries are stored. The ERP server 125 and ERP application 137 can integrate internal and external management information across an entire organization, including finance/accounting, manufacturing, sales and service, customer relationship management, and other functions. ERP systems can automate activities with the integrated ERP application 137. Generally, the purpose of ERP systems is to facilitate the flow of information between business functions inside the boundaries of the organization and manage the connections to outside stakeholders and entities. In the present example, the ERP applications 137 can provide information associated with particular shipments to the TM server 103, including information on the buyers, sellers, senders and receivers of a particular shipment. The TM server 103 and the TM application 115 can use the information derived from the ERP system to determine and calculate shipping routes, locations, potential shipping contracts and offers, and related metrics and instructions. That information can then be used to produce various requests for quotations (or offers) associated with different shipments, including those that are sent to the one or more mobile devices 145 for review and analysis.

The interface 128, processor 131, and memory 134 of the ERP server 125 may be similar to or different than the interface 106, processor 109, and memory 112 of the TM server 103. The interface 128 generally allows the ERP server 125 to communicate with network 118, the TM server 103, and/or other external systems. The processor 131 generally executes the ERP application 137 and other functionality and/or components associated with or included within the ERP server 125. In some instances, the ERP server 125 may connect directly to the TM server 103, such as when the ERP server 125 and the TM server 103 are combined on a single server or system. In some instances, the functionality of the TM server 103 may be included within the ERP server 125.

FIG. 1 further illustrates one or more mobile devices 145 described briefly above. Each mobile device 145 may be any mobile computer device operable to connect or communicate with the TM server 103 and/or the network 118 using a wireless or wireline connection. In particular, the mobile device 145 may be embodied as a cell phone, personal digital assistant (PDA), smart phone, wireless messaging device, tablet computer, netbook, or other suitable type of mobile computing device. There may be any number of mobile devices 145 associated with environment 100 at any point in time. At a high level, each mobile device 145 can include a processor 151, a GUI 160, one or more transport tendering applications 157, a memory 154, and an interface 148. In general, the mobile device 145 comprises an electronic computer device operable to receive, transmit, process, and/or store any appropriate data associated with the transport tendering application 157 and the corresponding TM application 115. In one example, the mobile device 145 may be a smartphone that includes an input device, such as a keypad, touch screen, mouse, trackball, or other device that can accept information, and an output device that conveys information associated with the operation of the mobile device, including digital data, visual information, or the GUI 160. Both the input device and the output device may include fixed or removable storage media, such as a magnetic computer disk, CD-ROM, or other suitable media to both receive input from and provide output to users of the mobile device 145 through the display, namely, the GUI 160.

The interface 148 of the mobile device 145 may be similar to the interface 106 of the TM server 103, in that it may comprise logic encoded in software and/or hardware in a suitable combination and operable to communicate with the network 118. More specifically, interface 148 may comprise software supporting one or more communication protocols such that the network 118 or hardware is operable to communicate physical signals to and from the mobile device 145. The interface 148 may be specially designed for mobile devices, and may allow for communications with data and cellular networks, as well as Wi-Fi connections.

Similarly, memory 154 of the mobile device 145 may include any memory or database module and may take the form of volatile or non-volatile memory including, without limitation, magnetic media, optical media, random access memory (RAM), read-only memory (ROM), removable media, or any other suitable local or remote memory component. For example, memory 154 may store the transport tendering application 157, backup data, parameters, cookies, variables, algorithms, instructions, rules, mobile device-specific information and instructions, or references thereto. As illustrated, memory 154 may include a set of transport tendering application settings 155. Those settings can include information on one or more TM servers 103 from which opportunities will be received and bids exchanged. In some instances, the mobile device 145 and the transport tendering application 157 may connect with a single TM server 103 and corresponding TM application 115 associated with a single shipping entity, while in other instances, the transport tendering application 157 may connect with a plurality of different TM servers 103 associated with one or more shipping entities. The application settings 155 can be set by a user of the mobile device 145, while in other instances, the application settings 155 may be pushed onto the mobile device 145 by an administrator associated with the mobile device 145 and the transport tendering application 157. In other words, the application settings 155 can define the shippers from which information regarding shipping and bidding opportunities is obtained. In some instances, the settings 155 can direct the mobile device 145 and the transport tendering application 157 to a single system (not illustrated) associated with a carrier for whom the user of the mobile device 145 works or is associated with. That single system can collect the plurality of shipping opportunities and provide them to the transport tendering applications 157 and mobile devices 145 of drivers and other employees associated with the carrier themselves, allowing the transport tendering application 157 to interact with a single system in obtaining the shipping opportunities. In those instances, the single system can relay any bids or responses received from the mobile transport tendering applications 157 to the corresponding TM servers 103 of the various shippers requesting bids. In some implementations, the bids and responses can also be sent directly to the corresponding TM servers 103 from the mobile device 145, even where the shipping opportunities are received from the single system. In general, the application settings 155 may be a table or other suitable file storing information defining one or more connections for the transport tendering application 157, via interface 148, to enable that can provide links to the corresponding systems to retrieve and interact with shipping opportunities provided by one or more shippers.

In some instances, processor 151 may be similar to processor 109. In other instances, the processor 151 may be a processor designed specifically for use in mobile devices such as smartphones or PDAs. Further, although illustrated as a single processor 151, the processor 151 may be implemented as multiple processors in the mobile device 145. Regardless of the type and number, the processor 151 executes instructions and manipulates data to perform the operations of the mobile device 145, including operations to receive and process information from the TM server 103, access data within memory 154, and execute the mobile transport tendering application 157, as well as perform other operations associated with the mobile device 145.

The transport tendering application 157 may be an application provided to one or more different mobile platforms that allows the mobile device 145 to communicate with the TM server 103 and the TM application 115. The transport tendering application 157 can be communicably connected to the TM server 103, and can be used to manage a carrier's or truck driver's (or other entity associated with the mobile device 145) interactions with the TM application 115, and specifically, its requests for quotations and quotations associated with particular transport jobs and operations. The transport tendering application 157 can, in some instances, interpret and decode received messages from the TM application 115 to present information associated with potential and available shipping job offers and possibilities. The functionality of the transport tendering application 157 can provide an essential tool for providing carriers and potential carriers with an overview of one or more requests for quotations available for shipping jobs, an overview of accepted and/or rejected shipping jobs, including the terms associated therewith, as well as interfaces capable of accepting, counter-offering, or rejecting one or more of those offers.

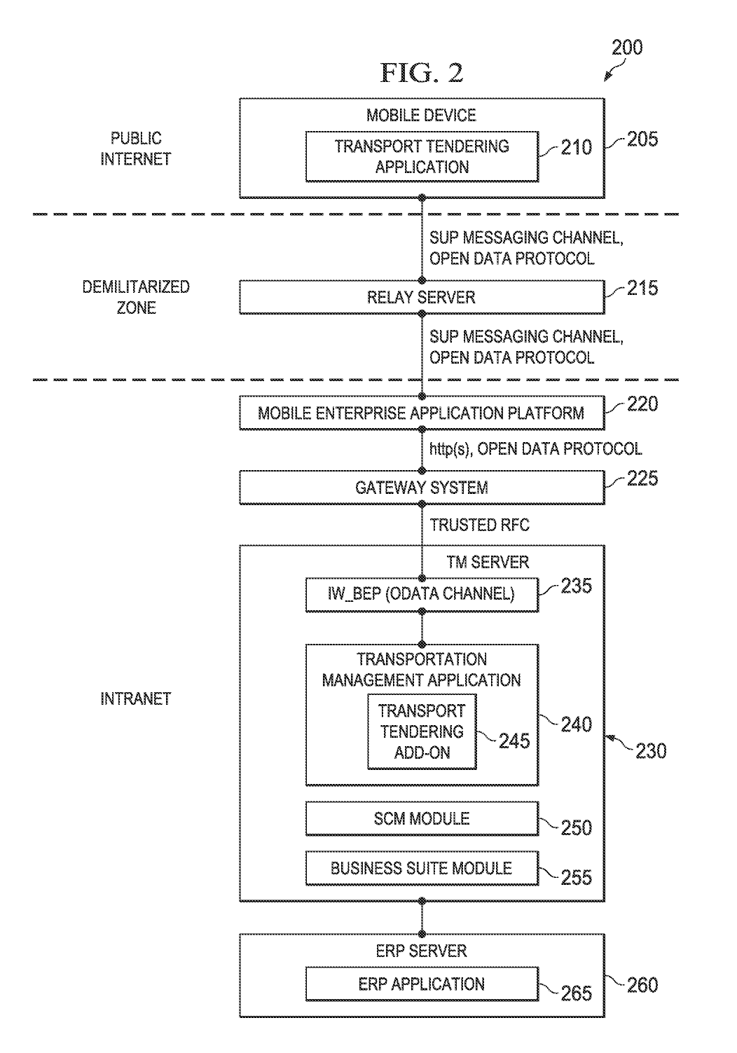

FIG. 2 illustrates an example interaction 200 between components in an architecture associated with the present disclosure. One or more of the example components may be omitted or additional components added in alternative implementations. In the illustrated example, a mobile device 205 includes a transport tendering application 210. In some instances, the mobile device 205 may be an iPhone®, iPad®, Android-based smartphone, or other suitable system. The transport tendering application 210 may be an “app” available in the corresponding mobile device's app store, such as the iTunes® or Android app stores. The mobile device 205 may be connected to the public internet, such as a home-based Wi-Fi connection, a 3G or 4G connection, or any other connection to a suitable network. The mobile device 205 may be operated by or associated with an individual, including a member or employee of a carrier or an independent truck driver, among others. Using a suitable open data protocol connection, the mobile device 205 connects to the relay server 215.

The relay server 215 is used to translate the call from the public internet (i.e., the mobile device 205) into an internal protocol associated with the TM server 230 and ERP server 260 systems. In general, the relay server 215 manages communications to and from a plurality of mobile devices 205, identifying the appropriate location for messages and events while returning responsive messages and events to the TM server 230. In this manner, the user of the mobile device 205 is able to access the internal systems associated with the TM server 230 through the public internet. The relay server 215 further communicates with a mobile enterprise application platform 220 (e.g., Sybase® Unwired Platform). The mobile enterprise application platform 220 can interpret incoming requests and communications from mobile devices 205 to a standard format, as well as package and structure outgoing responses or communications from the TM server 230 into an appropriate mobile device format or structure. The mobile enterprise application platform 220 can further offer services provided by a gateway system 225. Further interpretation and conversion of data can be performed through the gateway system 225, as needed, to provide an appropriate understanding of the data in the backend systems, such as the TM server 230.

The TM server 230 may be similar to the TM server 103 described in FIG. 1, and can include a TM application 240 similar to the TM application 115 of FIG. 1. As illustrated, the TM server 230 may be further associated with an SCM module 250 and a business suite module 255, providing additional supply chain management and business application functionality to the TM server 230. In some instances, the SCM module 250 and the business suite module 255 may provide interfaces for the TM server 103 and/or the TM application 240 to interact with and use SCM and business application functionality from one or more external systems. The TM server 230 further includes the IW_BEP 235, a component that describes and provides information on the metadata and mobile business objects that can be consumed and interacted with through the mobile devices 205 and the transport tendering applications 210. The IW_BEP component 235 may provide a channel through which information can be passed between the TM application 240 and the mobile device's transport tendering applications 210, including defining the available models and metadata that are consumable by the mobile devices 205. By providing mobile device-related communications entering or leaving the TM server 230 through the IW_BEP component 235, communications can be standardized for the system while interacting with the correct data objects associated with the mobile functionality. As illustrated, the TM application 240 includes a transport tendering add-on 245. The transport tendering add-on 245 allows the mobile data objects to be shared with and available for interaction with the one or more mobile devices 205 and the corresponding mobile transport tendering applications 210. Further, an optional ERP server 260 and a corresponding ERP application 265 are illustrated in FIG. 2. These are not required for use of the TM application 240 and the mobile functionality, but may provide additional information, functionality, and operations to the TM application 240, where appropriate or desired. Different components, combinations of components, and interactions can be used in alternative implementations. For instance, in some implementations, the mobile enterprise application platform 220, gateway system 225, and relay server 215 may be combined into a single component and/or layer, facilitating interactions between the mobile devices 205 and the TM server 230.

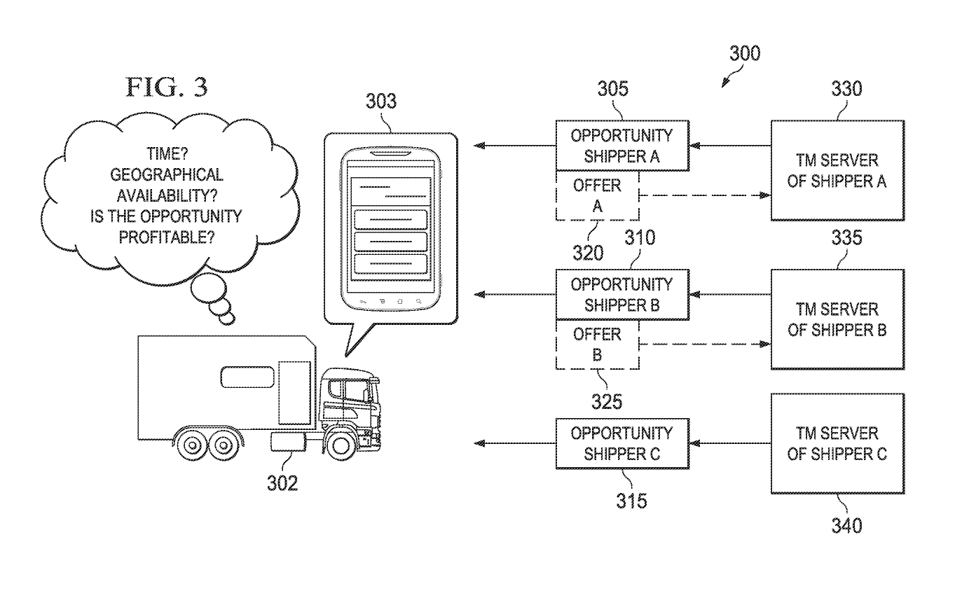

FIG. 3 provides an example diagram 300 of a carrier 302 (or individual truck driver of the carrier 302) receiving various transport opportunities via a mobile device 303 (e.g., a smartphone). As illustrated, the carrier 302 receives three particular transport opportunities 305, 310, and 315 from three different shippers, and has elected to respond to the opportunities 305, 310 from shipper A 330 and shipper B 335 with offer A 320 and offer B 325, respectively. In some instances, the carrier 302 may choose to later respond to opportunity C 315 from shipper C 340, while in other instances, a bidding window associated with opportunity C 315 may have closed such that further bidding is not available. Each shipper may be associated with a corresponding TM server, such as the TM server 103 illustrated in FIG. 1.

Each transport opportunity may be associated with various parameters, such as start date, end date, location, and other shipment-relevant information. Each carrier 302 or truck driver can review the opportunities on the mobile device 303 using the transport tendering application. At least four types of responses may be available to the carrier 302, including (1) an acceptance of the opportunity based on the terms as provided by the particular shipper; (2) an acceptance contingent on at least one modified parameter as defined by the carrier 302 on the mobile device 303; (3) an explicit rejection of the opportunity, and (4) an implicit rejection of the opportunity, such as the failure to respond to a particular shipment opportunity that has been delivered to and presented on the mobile device 303. The implicit rejection may be based on a bidding or acceptance timeout related to the opportunity and defined by the associated shipper or defined as a default value within the system (e.g., 48 hours prior to the shipment's start date). In some instances, the mobile transport tendering application on the mobile device 303 may perform an analysis and ranking of the potential transport opportunities or offers. The analysis and ranking may at least in part, consider previous accepted opportunities and shipments for the carrier 302, the carrier's current location, the expected location of the carrier on the start date, the availability of the carrier 302, and other relevant information associated with the carrier 302 and available to the mobile device 303. The results can be presented in an optimized manner on the mobile device 303, providing the carrier 302 an efficient review and analysis of the available opportunities. One or more user-defined criteria may also be defined by the carrier 302 to assist the analysis, such as preferred routes, times, and other shipment opportunity parameters.

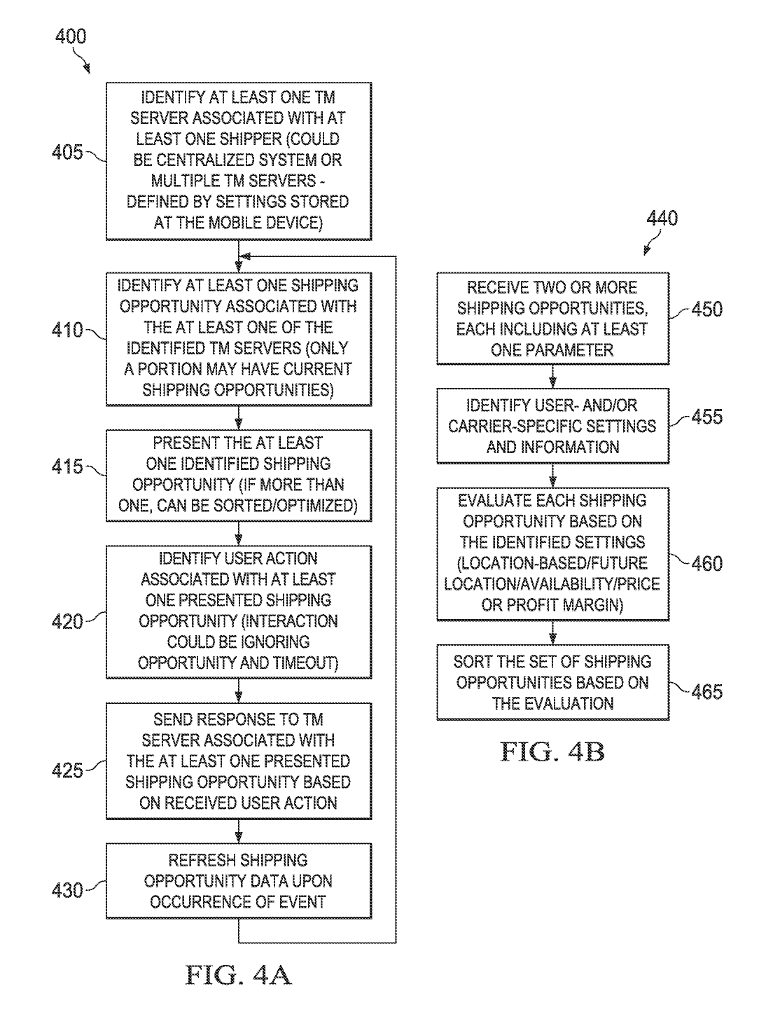

FIG. 4A is a flowchart of an example method 400 for identifying and interacting with at least one shipping opportunity at a mobile device. For clarity of presentation, the description that follows generally describes method 400 in the context of environment 100 illustrated in FIG. 1. However, it will be understood that method 400 may be performed, for example, by any other suitable system, environment, or combination of systems and environments, as appropriate.

At 405, at least one TM server associated with at least one shipper or shipping entity is identified. In some instances, two or more TM servers may be identified, such as when the mobile device and the transport tendering application are set to interact with, and receive shipping opportunities from, multiple shipping entities. In other instances, a single, centralized system may be identified, such as where the centralized system collects shipping opportunities for retrieval and interaction through a single location or address. Large carriers may find such an arrangement helpful, as the various TM servers and shippers can be collected at a single system, removing the need for the mobile device and transport tendering application to communicate with a plurality of TM servers individually. In some instances, 405 may be initiated when the transport tendering application is opened.

At 410, at least one shipping opportunity associated with the at least one of the identified TM servers is identified. The shipping opportunities may be identified in response to a request sent from the mobile device and the transport tendering application to at least a subset of the at least one of the identified TM servers. The requests can be sent via one or more network connections associated with the mobile device, and can include a set of information identifying the mobile device and its associated users and/or entities. In some instances, certain shopping opportunities may be available to certain entities or individuals and not to others. The identifying information can be used by the at least one of the identified TM servers to determine which shipping opportunities are to be returned to the mobile device and transport tendering application. In some cases, the information may further include real-time information associated with the user and/or the mobile device, including location information, availability information (e.g., calendar information stored on the mobile device, reference information identifying a remotely stored user account where availability information is stored, etc.). Identifying the at least one shipping opportunity may include receiving a set of information associated with one or more TM servers, where the sets of information including parameters defining each shipping opportunity, including but not limited to, start and end dates, the amount to be paid for the opportunity, start and end points of the transport, as well as other relevant data.

At 415, the at least one identified shipping opportunity identified at 410 is presented at the mobile device. Generally, the shipping opportunities are presented within a GUI associated with the transport tendering application. If more than one shipping opportunity is available and identified at 410, the two or more shipping opportunities can be sorted and prioritized at 415. FIG. 4B, described below, provides an example method 440 for storing and prioritizing the identified shipping opportunities. In some instances, only a subset of the identified shipping opportunities may be presented. In other instances, the entire set of shipping opportunities may be presented. In some instances, the user of the mobile device can apply manual sort and/or filter criteria to modify the presentation of shipping opportunities.

At 420, a user action associated with the presented shipping opportunities and the transport tendering application is identified. The user action may be received through a keyboard, buttons, touchscreen, voice control, or other suitable method, including an external component, such as a Bluetooth keyboard. In some instances, the user action associated with the transport tendering application may be inaction, such as the failure to enter or submit a response to a particular offer. In general, tour separate types of user actions may be associated with a particular shipping opportunity. Those user actions include (1) an action indicating the acceptance of a particular shipping opportunity based on the terms as provided by the shipper; (2) an action indicating acceptance of a particular shipping opportunity contingent on at least one modified parameter; (3) a user action indicating an explicit rejection of the shipping opportunity, such as selection of an “Ignore” or “No Response” button (in some instances, explicit rejections may mean a selection of a rejection reason in addition to a particular selection); and (4) user inaction indicating an implicit rejection of a particular shipping opportunity, such as the failure to respond to a particular shipment opportunity within a particular time period. In (2), the contingency may represent a counter-offer to the shipper, such as a modification to the dates of the shipping opportunity or to the amount to be paid to the carrier. When modifications are provided, an additional step may be included in method 400 (not illustrated), where the shipper or the shipper's TM server can respond to the counter-offer. Once the user action is identified, a response is generated and sent to the TM server associated with the at least one shipping opportunity at 425. In some instances, responses may not be sent until a user finalizes his actions and/or selections, or until a predetermined event occurs.

At 430, the shipping opportunity data can be refreshed upon the occurrence of a triggering event associated with a refresh. In some instances, the triggering event may be a manually submitted request to refresh the shipping opportunities from the user associated with the mobile device. In other instances, the triggering event may be the expiration of a predetermined period of time since the previous refresh. In still other instances, the refresh may be based on an indication from one or more TM servers that additional shipping opportunities are available for review. In those instances, messages or notifications in channels outside of the transport tendering application may be provided, such as through SMS messages, emails, or other suitable channels. In other instances, a push notification sent from a particular TM server may indicate that additional opportunities are available. In some instances, one or more shipping opportunities may be pushed to the mobile device. When the refresh occurs, method 400 can return to 410, where the additional shipping opportunities are identified.

FIG. 4B is a flowchart of an example method 440 for analyzing and sorting a plurality of shipping opportunities at a mobile device. For clarity of presentation, the description that follows generally describes method 440 in the context of environment 100 illustrated in FIG. 1. However, it will be understood that method 440 may be performed, for example, by any other suitable system, environment, or combination of systems and environments, as appropriate. Further, while method 440 is described as associated with 415 of FIG. 4A, alternative methods may be associated with method 440. In general, method 440 can be initiated when two or more shipping opportunities are identified and are to be presented, such as at 415 of FIG. 4A. While in some instances the shipping opportunities could be placed in alphabetical or chronological order, method 440 allows for the plurality of shipping opportunities to be analyzed based on parameters and data associated with each shipping opportunity, as well as settings and criteria associated with the user and his organization.

At 450, two or more shipping opportunities, each including at least one associated parameter defining the shipping opportunity, are received. The parameters can include a start time and location, an end time and location, a proposed route, a size and type of shipment, an amount to be paid, and other suitable shipping opportunity parameters. These parameters can be used to later evaluate the two or more shipping opportunities. At 455, settings associated with the user of the mobile device are identified. Those settings may include user- and/or carrier-specific settings and preferences that can be used to compare the two or more shipping opportunities. For instance, the user may be located in a particular region of the United States, and may prefer opportunities that can be performed and completed in that particular area. Additionally, information on the user's current location may be identified, such as through the mobile device's GPS data, such that shipping opportunities close in geographical proximity may be preferred. Similarly, information related to the user may include information retrieved from a calendar included on the mobile device, indicating one or more future locations (if location is specified) and/or specific availability of the device's user, allowing that information to be used to evaluate and compare potential shipping opportunities. Various other suitable sets of data may be identified at 455, including carrier-specific preferences defined throughout a company or entity. Those preferences (as well as user-specific preferences) may further include a particular profit margin threshold required for the user and/or carrier to accept the opportunity. In combination with the profit margin, some intelligence may be available at the mobile device to further calculate the costs of the shipping opportunity in order to determine the profit margin to be earned upon performance of the shipping opportunity. In some instances, information on current and/or previously accepted shipping opportunities may also be identified and used to determine if one or more of the shipping opportunities can be fulfilled and/or accepted,

At 460, each of the shipping opportunities is evaluated based on the parameters associated with the particular shipping opportunities in light of the identified settings. In some instances, a correlation score identifying the level of a match of a particular opportunity may be calculated for each opportunity. In some instances, one or more of the shipping opportunities may be removed from the set based on parameters outside the settings or preferences of the user or carrier associated with the user. For instance, if the profit margin for a particular shipping opportunity does not exceed a predetermined amount, that shipping opportunity may be removed from the current set. If the user is unavailable for a particular opportunity based on pre-existing commitments, including a previously accepted opportunity, then overlapping opportunities may be removed. Regardless of the particular method used to evaluate the shipping opportunities, each shipping opportunity can be effectively compared against the other opportunities after the evaluation. Using those comparable scores and/or evaluations, at 465 the set of shipping opportunities can be sorted, or prioritized, based on the previous evaluation. Those sorted opportunities can then be presented as described in FIG. 4B, and allow the user to view the prioritized set of shipping opportunities. The user can then provide one or more user-defined sort and/or filter criteria to the presented set of shipping opportunities, allowing for a personalized view of the results.

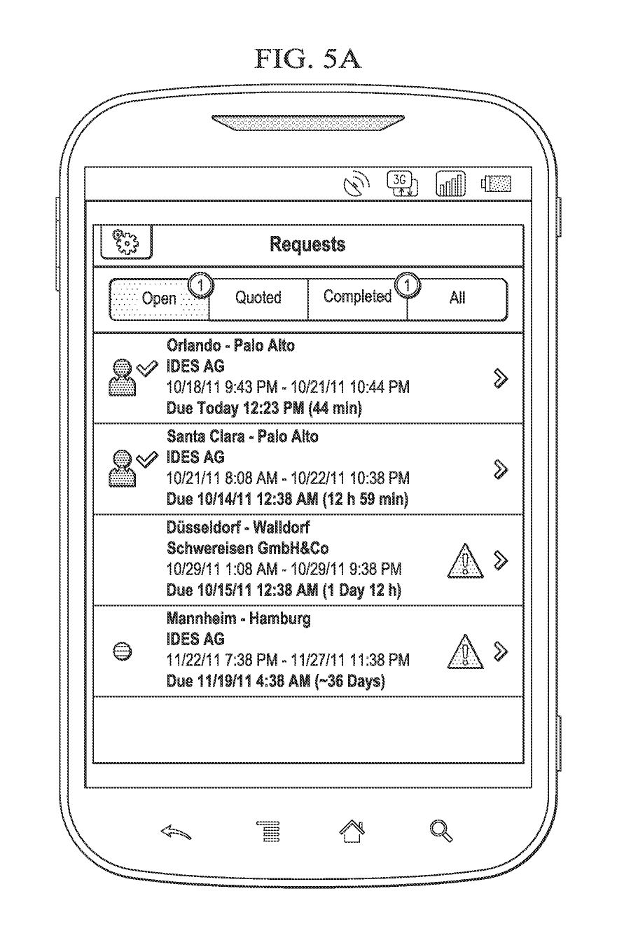

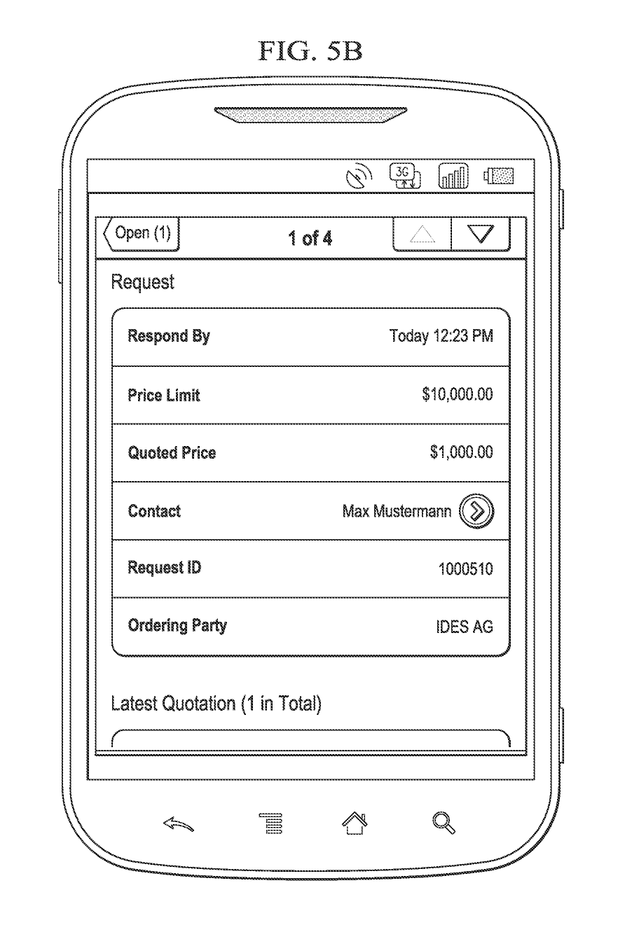

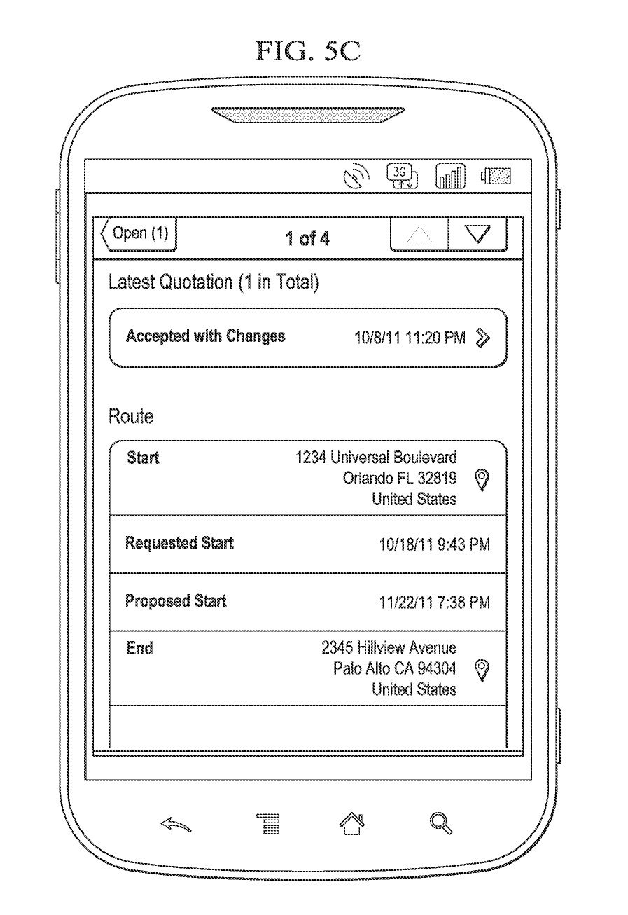

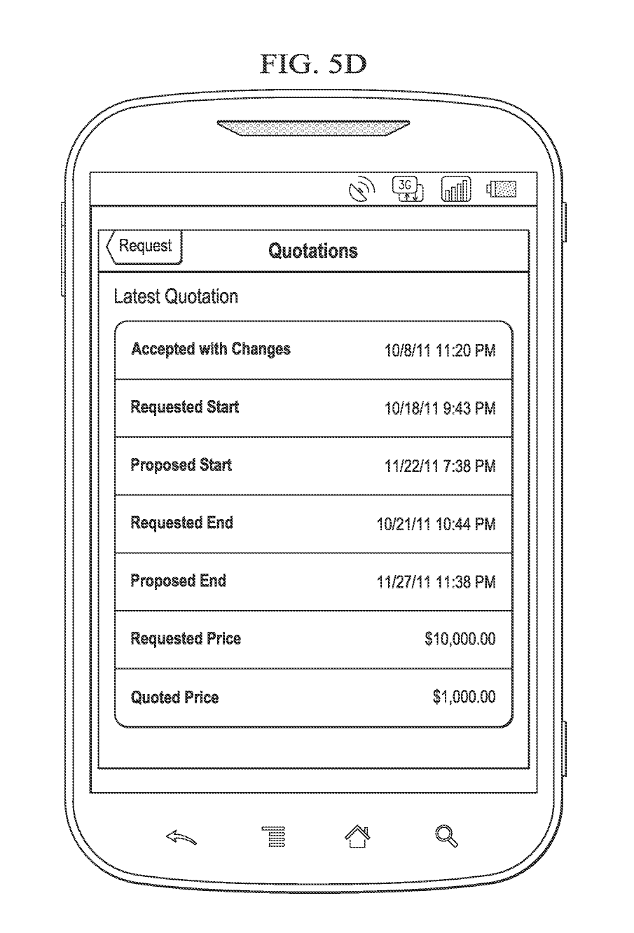

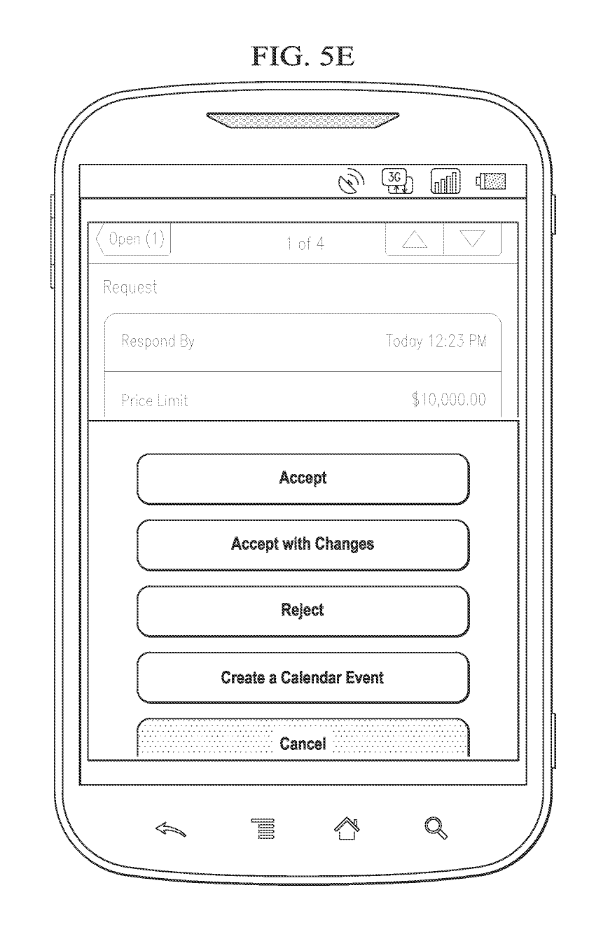

FIGS. 5A-E provide example screenshots from an example mobile transport tendering application used by carriers. FIG. 5A illustrates a view of four open opportunities, including their general location, timing requirements, and closing times for corresponding bids or quotes. Each of the opportunities can be opened for additional detail and the opportunity to submit a quote to the shipper, as illustrated by FIGS. 5B and 5C, FIG. 5D illustrates a quote for an opportunity in which the carrier has proposed modified opportunity parameters via the mobile application. FIG. 5E illustrates a screenshot of a carrier's example options for choosing to submit or reject a bid.

The preceding figures and accompanying description illustrate example processes and computer implementable techniques. But environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously, concurrently, and/or in different orders than as shown. Moreover, environment 100 may use processes with additional steps, fewer steps, and/or different steps, so long as the methods remain appropriate.

In other words, although this disclosure has been described in terms of certain embodiments and generally associated methods, alterations and permutations of these embodiments and methods will be apparent to those skilled in the art. For instance, while the present disclosure has been described in terms of a carrier or user associated with a carrier interacting with the transport tendering application, the mobile device and transport tendering application may be used by a user associated with a logistics service provider, and not a carrier. Accordingly, the above description of example embodiments does not define or constrain this disclosure. Other changes, substitutions, and alterations are also possible without departing from the spirit and scope of this disclosure

What is claimed is:

1. A computer-implemented method for mobile transport tendering, the method comprising:
identifying at least one transportation management server providing information on at least one shipping opportunity, each transportation management server associated with a shipper;
identifying the at least one shipping opportunity associated with at least one of the identified transportation management servers at a mobile device; and
presenting at least a subset of the at least one identified shipping opportunity at the mobile device.

2. The method of claim 1, wherein identifying the at least one shipping opportunity associated with the at least one of the identified transportation management servers includes:
sending a request to each of the at least one identified transportation management servers for shipping opportunities associated with the shipper; and
receiving a set of shipping opportunities from at least one of the identified transportation management servers.

3. The method of claim 1, wherein identifying the at least one transportation management server includes identifying a centralized system collecting information on shipping opportunities from a plurality of shippers.

4. The method of claim 1, wherein presenting the at least one identified shipping opportunity at the mobile device includes:
identifying at least one parameter associated with each identified shipping opportunity;
identifying at least one preference associated with the mobile device;
evaluating each identified shipping opportunity based, at least in part, on a comparison of at least a subset of the at least one parameter with at least a subset of the at least one identified preference; and
prioritizing the identified shipping opportunities based, at least in part, on the evaluation.

5. The method of claim 4, wherein the at least one identified parameter associated with each identified shipping opportunity includes at least one of the following: a start date, an end date, a start location, an end location, information relating to the size and type of a shipment, and payment information associated with the shipping opportunity.

6. The method of claim 4, wherein the at least one preference associated with the mobile device includes at least one of the following: a profit margin required for acceptable shipping opportunities, availability information associated with a user of the mobile device, geographical preferences for shipping opportunities, a current location of the user of the mobile device, and a future location of the user of the mobile device.

7. The method of claim 4, wherein at least one reference associated with the mobile device is defined by a carrier with which a user of the mobile device is associated.

8. The method of claim 4, wherein evaluating each identified shipping opportunity based, at least in part, on the comparison of the subset of the at least one parameters with at least a subset of the at least one identified preference includes removing at least one shipping opportunity from a set of shipping opportunities to be presented at the mobile device, where the at least one removed shipping opportunity fails to meet a minimum threshold value associated with the evaluation.

9. The method of claim 1, further comprising:
identifying a responsive user action associated a particular shipping opportunity from the presented subset of the at least one identified shipping opportunity; and
sending notification of the responsive user action associated with the particular shipping opportunity to the transport management server associated with the at least one shipping opportunity.

10. The method of claim 9, wherein the response user action includes at least one of the following: an acceptance of the particular shipping opportunity in accordance with one or more original parameters provided by the associated shipper; an acceptance of the particular shipping opportunity contingent upon at least one modified parameter as defined by the user; an explicit rejection of the particular shipping opportunity, or an implicit rejection of the particular shipping opportunity.

11. A computer program product encoded on a non-transitory storage medium, the product comprising computer readable instructions for causing one or more processors to perform operations comprising:
identifying at least one transportation management server providing information on at least one shipping opportunity, each transportation management server associated with a shipper;
identifying the at least one shipping opportunity associated with at least one of the identified transportation management servers at a mobile device; and
presenting at least a subset of the at least one identified shipping opportunity at the mobile device.

12. The product of claim 11, wherein identifying the at least one shipping opportunity associated with the at least one of the identified transportation management servers includes:
sending a request to each of the at least one identified transportation management servers for shipping opportunities associated with the shipper; and
receiving a set of shipping opportunities from at least one of the identified transportation management servers.

13. The product of claim 11, wherein identifying the at least one transportation management server includes identifying a centralized system collecting information on shipping opportunities from a plurality of shippers.

14. The product of claim 11, wherein presenting the at least one identified shipping opportunity at the mobile device includes:
identifying at least one parameter associated with each identified shipping opportunity;
identifying at least one preference associated with the mobile device;
evaluating each identified shipping opportunity based, at least in part, on a comparison of at least a subset of the at least one parameter with at least a subset of the at least one identified preference; and
prioritizing the identified shipping opportunities based, at least in part, on the evaluation.

15. The product of claim 14, wherein the at least one identified parameter associated with each identified shipping opportunity includes at least one of the following: a start date, an end date, a start location, an end location, information relating to the size and type of a shipment, and payment information associated with the shipping opportunity.

16. The product of claim 14, wherein the at least one preference associated with the mobile device includes at least one of the following: a profit margin required for acceptable shipping opportunities, availability information associated with a user of the mobile device, geographical preferences for shipping opportunities, a current location of the user of the mobile device, and a future location of the user of the mobile device.

17. The product of claim 11, wherein evaluating each identified shipping opportunity based, at least in part, on the comparison of the subset of the at least one parameters with at least a subset of the at least one identified preference includes removing at least one shipping opportunity from a set of shipping opportunities to be presented at the mobile device, where the at least one removed shipping opportunity fails to meet a minimum threshold value associated with the evaluation.

18. The product of claim 11, further comprising:
identifying a responsive user action associated a particular shipping opportunity from the presented subset of the at least one identified shipping opportunity; and
sending notification of the responsive user action associated with the particular shipping opportunity to the transport management server associated with the at least one shipping opportunity.

19. The product of claim 18, wherein the response user action includes at least one of the following: an acceptance of the particular shipping opportunity in accordance with one or more original parameters provided by the associated shipper; an acceptance of the particular shipping opportunity contingent upon at least one modified parameter as defined by the user; an explicit rejection of the particular shipping opportunity, or an implicit rejection of the particular shipping opportunity.

20. A system, comprising:
one or more computers; and
a computer-readable medium coupled to the one or more computers having instructions stored thereon which, when executed by the one or more computers, cause the one or more computers to perform operations comprising:
identifying at least one transportation management server providing information on at least one shipping opportunity, each transportation management server associated with a shipper;
identifying the at least one shipping opportunity associated with at least one of the identified transportation management servers at a mobile device; and
presenting at least a subset of the at least one identified shipping opportunity at the mobile device.
